(19) United States
(12) Patent Application Publication
(10) Pub. No.: US 2025/0244617 A1
(43) Pub. Date: Jul. 31, 2025

(54) PHASE SHIFTER AND WAVELENGTH SELECTOR

(71) Applicant: SUMITOMO ELECTRIC INDUSTRIES, LTD., Osaka (JP)

(72) Inventors: Yoshiyuki SUGIMOTO, Osaka-shi (JP); Keiji TANAKA, Osaka-shi (JP)

(73) Assignee: SUMITOMO ELECTRIC INDUSTRIES, LTD., Osaka (JP)

(21) Appl. No.: 19/034,012

(22) Filed: Jan. 22, 2025

(30) Foreign Application Priority Data
Jan. 26, 2024 (JP) 2024-010215

(51) Int. Cl. G02F 1/01

(52) U.S. Cl. CPC G02F 1/0147

(57) ABSTRACT

A phase shifter according to one embodiment includes a substrate; an optical waveguide disposed in a vertical direction with respect to the substrate; a first temperature measuring element and a second temperature measuring element disposed in a horizontal direction with respect to the optical waveguide, and disposed to sandwich the optical waveguide between the first temperature measuring element and the second temperature measuring element; and a heating element disposed in the vertical direction with respect to the optical waveguide, the first temperature measuring element, and the second temperature measuring element.

### CROSS-REFERENCE TO RELATED APPLICATION

This application claims priority from Japanese Patent Application No. 2024-010215, filed on Jan. 26, 2024, the entire subject matter of which is incorporated herein by reference.

### TECHNICAL FIELD

The present disclosure relates to a phase shifter and a wavelength selector.

### BACKGROUND OF THE INVENTION

A specification of U.S. Pat. No. 11,556,020 describes a wavelength selector. The wavelength selector includes a ring resonator, a temperature sensor, and a heater. The temperature sensor is disposed inside a semiconductor substrate that is a silicon substrate. The ring resonator and the heater are disposed inside an insulating layer made of silicon dioxide. The heater, the ring resonator, and the temperature sensor are arranged along a vertical direction. The ring resonator is disposed between the heater and the temperature sensor in the vertical direction. In a plan view of the wavelength selector, the heater, the ring resonator, and the temperature sensor have an annular shape. The temperature sensor is configured by a PN junction. The wavelength selector includes a groove located inside the heater in a plan view of the wavelength selector.

International Publication WO 2008/111407 describes a thermo-optic phase shifter. The thermo-optic phase shifter includes a Si substrate, a sacrificial layer, a lower cladding layer, an upper cladding layer, and a heater. The upper cladding is provided with an optical waveguide core layer. In a plan view of the thermo-optic phase shifter, the heater and the upper cladding layer have an arc shape. The thermo-optic phase shifter includes a groove outside the heater in a plan view.

### SUMMARY OF THE INVENTION

A phase shifter according to the present disclosure includes a substrate; an optical waveguide disposed in a vertical direction with respect to the substrate; a first temperature measuring element and a second temperature measuring element disposed in a horizontal direction with respect to the optical waveguide, and disposed to sandwich the optical waveguide between the first temperature measuring element and the second temperature measuring element; and a heating element disposed in the vertical direction with respect to the optical waveguide, the first temperature measuring element, and the second temperature measuring element.

### BRIEF DESCRIPTION OF THE DRAWINGS

FIG. 1 is a plan view showing a phase shifter according to an embodiment.

FIG. 2 is a cross-sectional view taken along line A-A of FIG. 1.

FIG. 3 is a cross-sectional view taken along line B-B of FIG. 1.

FIG. 4 is a cross-sectional view showing a phase shifter according to a first modification example.

FIG. 5 is a plan view showing a phase shifter according to a second modification example.

FIG. 6 is a cross-sectional view taken along line C-C of FIG. 5.

FIG. 7 is a plan view showing a wavelength selector according to an embodiment.

FIG. 8 is a cross-sectional view taken along line D-D of FIG. 7.

FIG. 9 is a cross-sectional view showing a phase shifter according to a comparative example.

### DETAILED DESCRIPTION

In a photonic integrated circuit using silicon photonics technology, the phase of an optical signal propagating through an optical waveguide can be changed by heating the optical waveguide using a heating element such as a heater. A photonic circuit that changes the phase of the optical signal is referred to as a phase shifter. In the phase shifter, the amount of phase shift (amount of change in phase) is changed by adjusting electric power supplied to the heating element. For example, when the wavelength of an optical signal is controlled, it may be necessary to continuously supply a relatively large amount of electric power to the heating element for a long period of time. However, the resistance value of the heating element may change, for example, due to long-term use. When the resistance value of the heating element changes, a problem in which the amount of phase shift in response to the supplied electric power deviates from a desired value may occur. Therefore, stabilizing the amount of phase shift with respect to a change in the resistance value of the heating element may be required.

An object of the present disclosure is to provide a phase shifter and a wavelength selector capable of stabilizing the amount of phase shift with respect to a change in the resistance value of a heating element.

According to the present disclosure, it is possible to stabilize the amount of phase shift with respect to a change in the resistance value of the heating element.

### Description of Embodiment of Present Disclosure

First, the contents of embodiments of the present disclosure will be listed and described.
(1) A phase shifter according to one embodiment includes a substrate; an optical waveguide disposed in a vertical direction with respect to the substrate; a first temperature measuring element and a second temperature measuring element disposed in a horizontal direction with respect to the optical waveguide, and disposed to sandwich the optical waveguide between the first temperature measuring element and the second temperature measuring element; and a heating element disposed in the vertical direction with respect to the optical waveguide, the first temperature measuring element, and the second temperature measuring element.

In the phase shifter, the optical waveguide is disposed in the vertical direction with respect to the substrate. The phase shifter includes the optical waveguide, and the first temperature measuring element and the second temperature measuring element disposed to sandwich the optical waveguide therebetween. The heating element is disposed in the vertical direction with respect to the optical waveguide, the first temperature measuring element, and the second temperature measuring element. The heating element is disposed in the vertical direction with respect to the optical waveguide, the first temperature measuring element, and the second temperature measuring element, and the optical waveguide is disposed between the first temperature measuring element and the second temperature measuring element. The first temperature measuring element and the second temperature measuring element located on both sides of the optical waveguide in the horizontal direction monitor the temperature of the optical waveguide, and electric power to the heating element is controlled such that the monitored temperature reaches a predetermined value, so that the temperature of the optical waveguide can be stabilized to reach the predetermined value. Therefore, even when the resistance value of the heating element changes due to long-term use or the like, electric power to the heating element can be controlled according to the monitored temperature, so that deviation in the amount of phase shift can be suppressed and the amount of phase shift can be stabilized.
(2) In the above (1), in a plan view along the vertical direction, the heating element may include a portion overlapping the optical waveguide, and a portion overlapping at least one of the first temperature measuring element and the second temperature measuring element. In this case, since the heating element includes the portion overlapping the optical waveguide, and the portion overlapping at least one of the first temperature measuring element and the second temperature measuring element, the temperature of the optical waveguide and the temperature of at least one of the first temperature measuring element and the second temperature measuring element can be made to approach each other uniformly. Therefore, since the temperature of the optical waveguide can be monitored with higher accuracy by at least one of the first temperature measuring element and the second temperature measuring element, the amount of phase shift can be further stabilized.
(3) In the above (1) or (2), the optical waveguide may be made of silicon, and the first temperature measuring element and the second temperature measuring element may be made of salicide. A temperature coefficient of the resistance value of salicide is approximately five times a temperature coefficient of the resistance value of titanium nitride (TiN). Therefore, when the first temperature measuring element and the second temperature measuring element are made of salicide, the sensitivity of the first temperature measuring element and the second temperature measuring element to changes in temperature can be enhanced. As a result, the temperature of the optical waveguide can be monitored with higher accuracy, so that the amount of phase shift can be further stabilized.
(4) In any one of the above (1) to (3), one end of the first temperature measuring element may be connected to one end of the second temperature measuring element. In this case, the first temperature measuring element is connected in series to the second temperature measuring element. By connecting the first temperature measuring element in series to the second temperature measuring element, the resistance values of the first temperature measuring element and the second temperature measuring element can be increased. Therefore, the accuracy of temperature detection by the first temperature measuring element and the second temperature measuring element can be further enhanced.
(5) A wavelength selector according to one embodiment includes the phase shifter according to any one of the above-described (1) to (4). Therefore, in the wavelength selector, similarly to the above-described phase shifter, since electric power to the heating element can be controlled according to the monitored temperature, the amount of phase shift can be stabilized.

### Details of Embodiment of Present Disclosure

Specific examples of phase shifters and wavelength selectors according to embodiments of the present disclosure will be described with reference to the drawings. Incidentally, the present invention is not limited to the following example, and includes all modifications within the scope of the claims and equivalents to the claims. In the description of the drawings, the same or corresponding elements are denoted by the same reference signs, and duplicate descriptions will be omitted as appropriate. The drawings may be depicted partially in a simplified or exaggerated manner for ease of understanding, and dimensional ratios and the like are not limited to those shown in the drawings.

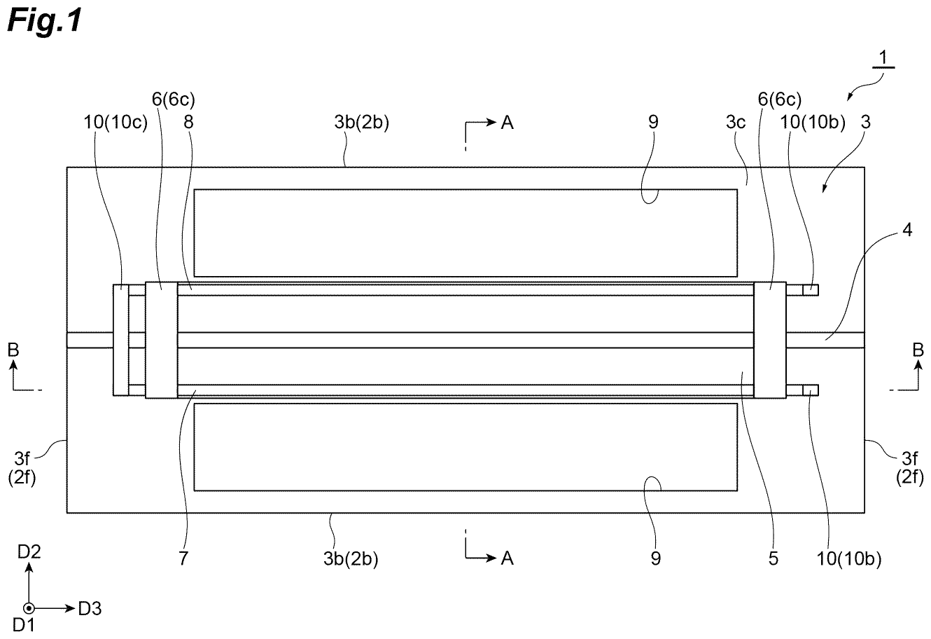

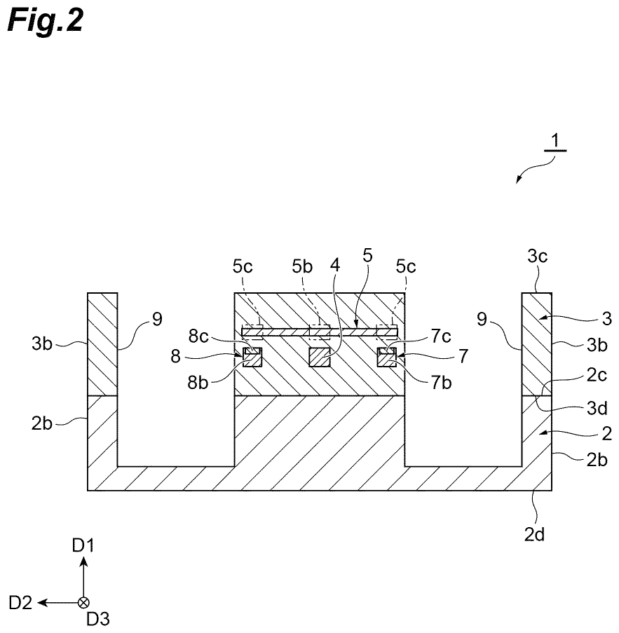

FIG. 1 is a plan view showing a phase shifter 1 according to a first embodiment. FIG. 2 is a cross-sectional view showing the phase shifter 1 taken along line A-A. The phase shifter 1 is used, for example, in a Mach-Zehnder interferometer or a ring resonator to control the wavelength characteristics of an optical signal. As shown in FIGS. 1 and 2, the phase shifter 1 includes a substrate 2; a silicon dioxide (SiO₂) layer 3 laminated on the substrate 2; and an optical waveguide 4 formed inside the SiO₂ layer 3. For ease of illustration, each component is shown by a solid line in FIG. 1. An optical signal propagates through the optical waveguide 4. The phase shifter 1 includes a heating element 5 disposed in a vertical direction D1 with respect to the optical waveguide 4. The optical waveguide 4 is disposed between the substrate 2 and the heating element 5 in the vertical direction D1. The optical waveguide 4 has a width in a horizontal direction D2 intersecting (for example, perpendicular to) the vertical direction D1, and extends along an extending direction D3 intersecting both the vertical direction D1 and the horizontal direction D2.

In the present embodiment, the “vertical direction” indicates a direction in which the optical waveguide 4 is located when viewed from the substrate 2. In the following description, the vertical direction may be referred to as the top, upper side, or upward, and a direction opposite to the vertical direction may be referred to as the bottom, lower side, or downward. In the present embodiment, the “horizontal direction” indicates a width direction of the optical waveguide 4, and the “extending direction” indicates a direction in which the optical waveguide 4 extends. However, these directions are for convenience of description, and do not limit the disposition positions, directions, or the like of the components.

The substrate 2 is made of silicon (Si). The substrate 2 has a rectangular parallelepiped shape. For example, a length of the substrate 2 in the vertical direction D1 is shorter than a length of the substrate 2 in the horizontal direction D2. The length of the substrate 2 in the horizontal direction D2 is shorter than a length of the substrate 2 in the extending direction D3. The length of the substrate 2 in the horizontal direction D2 corresponds to a width of the substrate 2, and the length of the substrate 2 in the vertical direction D1 corresponds to a thickness of the substrate 2. The substrate 2 has a first side surface 2b extending along both the vertical direction D1 and the extending direction D3; an upper surface 2c and a lower surface 2d extending along both the horizontal direction D2 and the extending direction D3; and a second side surface 2f extending along both the vertical direction D1 and the horizontal direction D2. The substrate 2 has a pair of the first side surfaces 2b arranged along the horizontal direction D2, and for example, the pair of first side surfaces 2b extend parallel to each other. The upper surface 2c is in contact with the SiO₂ layer 3. For example, the upper surface 2c and the lower surface 2d extend parallel to each other. The substrate 2 has a pair of the second side surfaces 2f arranged along the extending direction D3, and for example, the pair of second side surfaces 2f extend parallel to each other.

The SiO₂ layer 3 has a rectangular parallelepiped shape. A length of the SiO₂ layer 3 in the vertical direction D1 is shorter than a length of the SiO₂ layer 3 in the horizontal direction D2. The length of the SiO₂ layer 3 in the horizontal direction D2 is shorter than a length of the SiO₂ layer 3 in the extending direction D3. The length of the SiO₂ layer 3 in the horizontal direction D2 corresponds to a width of the SiO₂ layer 3, and the length of the SiO₂ layer 3 in the vertical direction D1 corresponds to a thickness of the SiO₂ layer 3. The SiO₂ layer 3 has a first side surface 3b extending along both the vertical direction D1 and the extending direction D3; an upper surface 3c and a lower surface 3d extending along both the horizontal direction D2 and the extending direction D3; and a second side surface 3f extending along both the vertical direction D1 and the horizontal direction D2.

The SiO₂ layer 3 has a pair of the first side surfaces 3b arranged along the horizontal direction D2, and for example, the pair of first side surfaces 3b extend parallel to each other. The lower surface 3d is in contact with the upper surface 2c of the substrate 2. For example, the upper surface 3c and the lower surface 3d extend parallel to each other. The SiO₂ layer 3 has a pair of the second side surfaces 3f arranged along the extending direction D3, and for example, the pair of second side surfaces 3f extend parallel to each other.

By the way, the phase shifter 1 can be formed as a part of a photonic integrated circuit on a silicon chip. In that case, the substrate 2 and the SiO₂ layer 3 are continuous with other portions of the photonic integrated circuit in the horizontal direction D2 and the extending direction D3, and the first side surfaces 2b and 3b and the second side surfaces 2f and 3f do not exist. Therefore, for the sake of convenience, the first side surfaces 2b and 3b and the second side surfaces 2f and 3f represent boundary surfaces with the other portions of the phase shifter 1.

The optical waveguide 4 is made of, for example, silicon (Si). However, the optical waveguide 4 may be made of silicon nitride (SiN) or Si. The optical waveguide 4 may be a Si slot waveguide that confines light between a pair of thin wires parallel to each other. In such a manner, the material and configuration of the optical waveguide 4 are not particularly limited. The optical waveguide 4 is disposed in the vertical direction D1 with respect to the substrate 2. The phase shifter 1 includes an electrode 6 that supplies electric power to the heating element 5; a first temperature measuring element 7 and a second temperature measuring element 8 disposed in the horizontal direction D2 with respect to the optical waveguide 4; and an electrode 10 electrically connected to the first temperature measuring element 7 and the second temperature measuring element 8. The optical waveguide 4, the heating element 5, the electrode 6, the first temperature measuring element 7, the second temperature measuring element 8, and the electrode 10 are provided inside the SiO₂ layer 3. For example, a distance from the substrate 2 to the first temperature measuring element 7 and a distance from the substrate 2 to the second temperature measuring element 8 are the same as a distance from the substrate 2 to the optical waveguide 4. In the vertical direction D1, the distance from the substrate 2 to the optical waveguide 4 may be 2 μm or more.

The optical waveguide 4 extends, for example, along the extending direction D3 at the center of the phase shifter 1 in the horizontal direction D2. End portions of the optical waveguide 4 in the extending direction D3 are exposed from the respective second side surfaces 3f of the SiO₂ layer 3. A cross section of the optical waveguide 4 cut by a plane extending in both the vertical direction D1 and the horizontal direction D2 has an oblong shape having first sides extending along the vertical direction D1 and second sides extending along the horizontal direction D2. For example, a length of the optical waveguide 4 in the extending direction D3 is 100 μm or more and several mm or less, and a length (width) of the second sides of the optical waveguide 4 is 0.2 μm or more and 1 μm or less. A length (thickness) of the first sides of the optical waveguide 4 is, for example, 0.4 μm or more and 0.5 μm or less.

The heating element 5 is located above the optical waveguide 4. The heating element 5 has, for example, a flat plate shape extending along both the horizontal direction D2 and the extending direction D3, and having a thickness in the vertical direction D1. A length of the heating element 5 in the vertical direction D1 is shorter than a length of the heating element 5 in the horizontal direction D2. The length of the heating element 5 in the horizontal direction D2 is shorter than a length of the heating element 5 in the extending direction D3. In a cross section cut by a plane extending in both the vertical direction D1 and the horizontal direction D2, the heating element 5 has an oblong shape having first sides extending along the vertical direction D1 and second sides extending along the horizontal direction D2. For example, the length of the heating element 5 in the extending direction D3 is 100 μm or more and several mm or less, and a length (width) of the second sides of the heating element 5 is several μm or more and several tens of μm or less. The length (width) of the second sides of the heating element 5 maybe 1 μm or more and 20 μm or less. A length (thickness) of the first sides of the heating element 5 is, for example, 0.1 μm or more and several μm or less.

The heating element 5 is disposed in the vertical direction D1 with respect to the optical waveguide 4, the first temperature measuring element 7, and the second temperature measuring element 8. The heating element 5 is located above the first temperature measuring element 7 and the second temperature measuring element 8. The optical waveguide 4, the first temperature measuring element 7, and the second temperature measuring element 8 are disposed between the substrate 2 and the heating element 5 in the vertical direction D1. For example, a distance from the heating element 5 to the first temperature measuring element 7 and a distance from the heating element 5 to the second temperature measuring element 8 are the same as a distance from the heating element 5 to the optical waveguide 4. In the vertical direction D1, the distance from the heating element 5 to the optical waveguide 4 may be 2 μm or more. The heating element 5 includes a portion 5b overlapping the optical waveguide 4, and a portion 5c overlapping at least one of the first temperature measuring element 7 and the second temperature measuring element 8 in a plan view along the vertical direction D1. In an example of FIG. 2, the heating element 5 includes a pair of the portions 5c arranged along the horizontal direction D2. The pair of portions 5c are the portion 5c overlapping the first temperature measuring element 7, and the portion 5c overlapping the second temperature measuring element 8 in a plan view along the vertical direction D1. The heating element 5 extends along the horizontal direction D2 above the optical waveguide 4, the first temperature measuring element 7, and the second temperature measuring element 8.

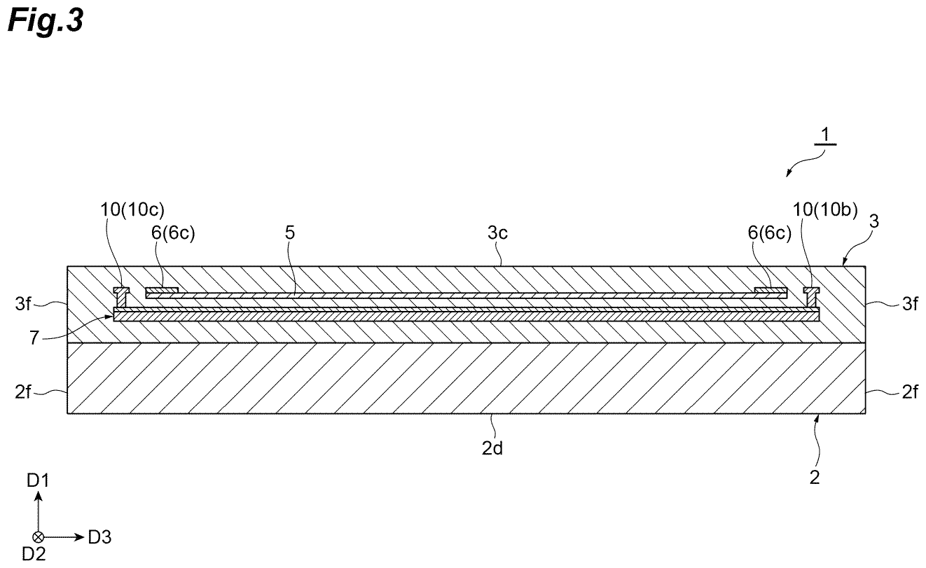

FIG. 3 is a cross-sectional view taken along line B-B of FIG. 1. As shown in FIGS. 1, 2, and 3, the phase shifter 1 includes the electrodes 6 electrically connected to end portions of the heating element 5 in the extending direction D3. For example, one electrode 6 is disposed on a first end portion of the heating element 5 in the extending direction D3, and another electrode 6 is disposed on a second end portion of the heating element 5 in the extending direction D3. The phase shifter 1 further includes the electrode 10 electrically connected to the first temperature measuring element 7 and the second temperature measuring element 8. The electrode 10 includes a first electrode 10b located at an end portion of each of the first temperature measuring element 7 and the second temperature measuring element 8 in the extending direction D3, and a second electrode 10c connecting the first temperature measuring element 7 and the second temperature measuring element 8 to each other. The first electrodes 10b protrude upward from each of the first temperature measuring element 7 and the second temperature measuring element 8. The first electrode 10b is disposed at each of a first end portion of the first temperature measuring element 7 in the extending direction D3 and a first end portion of the second temperature measuring element 8 in the extending direction D3. The second electrode 10c is disposed on a second end portion of the first temperature measuring element 7 in the extending direction D3 and a second end portion of the second temperature measuring element 8 in the extending direction D3.

In a plan view along the vertical direction D1, the second electrode 10c has an oblong shape having first sides extending along the horizontal direction D2, and second sides extending along the extending direction D3. The second electrode 10c is disposed on the first temperature measuring element 7 and the second temperature measuring element 8 to straddle the optical waveguide 4. The second electrode 10c electrically connects the second end portion of the first temperature measuring element 7 and the second end portion of the second temperature measuring element 8 to each other. The electrode 6 includes a pair of electrodes 6c arranged along the extending direction D3. In a plan view along the vertical direction D1, the electrodes 6c are located inside (center side) the first electrodes 10b and the second electrode 10c in the extending direction D3. Namely, the electrodes 6c are located between the first electrodes 10b and the second electrode 10c in the extending direction D3.

In the phase shifter 1, electric power is supplied to the heating element 5 via the electrodes 6. When electric power is supplied to the heating element 5, the heating element 5 generates heat, and the optical waveguide 4 is heated by the heat generation of the heating element 5. The heated optical waveguide 4 changes the phase of an optical signal propagating through the optical waveguide 4 by changing the refractive index due to the thermo-optic effect thereof. In the phase shifter 1, the temperature of the optical waveguide 4 changes due to the electric power supplied to the heating element 5, and the amount of phase shift (the amount of change in phase) of the optical signal propagating through the optical waveguide 4 is adjusted by the change in the temperature of the optical waveguide 4. For example, a temperature range ΔT of the optical waveguide 4 used for adjustment is 100° C. or less, and the amount of phase shift corresponding thereto is π or more and nπ (n is a natural number larger than or equal to 2) or less.

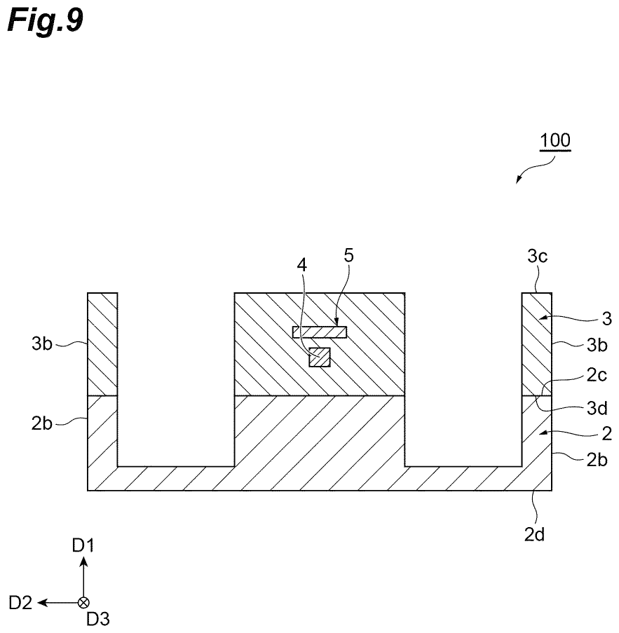

FIG. 9 is a cross-sectional view showing a phase shifter 100 according to a comparative example. The phase shifter 100 includes the substrate 2; the SiO₂ layer 3 located on the substrate 2; one optical waveguide 4 disposed inside the SiO₂ layer 3; and one heating element 5 located above the optical waveguide 4 inside the SiO₂ layer 3. The phase shifter 100 does not include the first temperature measuring element 7 and the second temperature measuring element 8. The heating element 5 may operate for a long period of time in a state where, for example, a large electric power of 50 mW or more and several hundred mW or less is supplied. A resistance value of the heating element 5 is, for example, 100Ω or more and several hundred Ω or less. The resistance value of the heating element 5 may change when the heating element 5 deteriorates over time due to long-term use. In this case, the amount of heat generated by the heating element 5 in response to the electric power supplied to the heating element 5 may change, and when the amount of heat generated by the heating element 5 changes, the temperature of the optical waveguide 4 also changes, so that the amount of phase shift of the optical signal propagating through the optical waveguide 4 may deviate.

In the present embodiment, as shown in FIGS. 1, 2, and 3, the deviation in the amount of phase shift is compensated for by disposing the first temperature measuring element 7 and the second temperature measuring element 8 on both respective sides of the optical waveguide 4 in the horizontal direction D2 below the heating element 5. The first temperature measuring element 7 and the second temperature measuring element 8 are disposed to sandwich the optical waveguide 4 therebetween in the horizontal direction D2. The first temperature measuring element 7 and the second temperature measuring element 8 are disposed along the optical waveguide 4 and the heating element 5 (for example, along the same direction as the optical waveguide 4 and the heating element 5). The first temperature measuring element 7 and the second temperature measuring element 8 are disposed below the heating element 5 to be separated from the optical waveguide 4 such that the first temperature measuring element 7 and the second temperature measuring element 8 are not coupled with the optical signal propagating through the optical waveguide 4. In the horizontal direction D2, a distance from the first temperature measuring element 7 to the optical waveguide 4 may be equal to a distance from the second temperature measuring element 8 to the optical waveguide 4. The distance from the first temperature measuring element 7 to the optical waveguide 4 and the distance from the second temperature measuring element 7 to the optical waveguide 4 may be 2 μm or more. For high precision monitoring of the temperature of the optical waveguide 4, the distance from the first temperature measuring element 7 to the optical waveguide 4 and the distance from the second temperature measuring element 7 to the optical waveguide 4 may be 10 μm or less. For example, in a plan view along the vertical direction D1, each of the first temperature measuring element 7 and the second temperature measuring element 8 overlaps the end portions in the horizontal direction D2 of the heating element 5.

For example, a length of the first temperature measuring element 7 in the extending direction D3 is 100 μm or more and several mm or less, and a length (width) of the first temperature measuring element 7 in the horizontal direction D2 is 0.5 μm or more and several μm or less. A length (thickness) of the first temperature measuring element 7 in the vertical direction D1 is, for example, 0.4 μm or more and 0.5 μm or less. For example, a length of the second temperature measuring element 8 in the extending direction D3, a length of the second temperature measuring element 8 in the horizontal direction D2, and a length of the second temperature measuring element 8 in the vertical direction D1 are the same as above.

For example, the first temperature measuring element 7 and the second temperature measuring element 8 are made of salicide. Namely, each of the first temperature measuring element 7 and the second temperature measuring element 8 includes a salicide layer (salicide resistor). For example, the first temperature measuring element 7 includes a silicon layer 7b and a salicide layer 7c located on the upper side of the silicon layer 7b. Similarly, the second temperature measuring element 8 includes a silicon layer 8b and a salicide layer 8c located on the upper side of the silicon layer 8b.

The resistance value of the first temperature measuring element 7 and the resistance value of the second temperature measuring element 8 change depending on the temperature. In the present embodiment, the first temperature measuring element 7 and the second temperature measuring element 8 are temperature monitors. The temperature of the optical waveguide 4 can be detected based on the change in the resistance values of the first temperature measuring element 7 and the second temperature measuring element 8. The phase shifter 1 monitors the resistance value of the first temperature measuring element 7 and the resistance value of the second temperature measuring element 8 that changes with temperature, and controls the supply of electric power to the heating element 5 such that the resistance value of the first temperature measuring element 7 and the resistance value of the second temperature measuring element 8 reach predetermined values. Accordingly, even when the resistance value of the heating element 5 changes due to long-term use or the like, the amount of heat generated by the heating element 5 and the temperature of the optical waveguide 4 can be appropriately adjusted, so that deviation in the amount of phase shift of the optical signal propagating through the optical waveguide 4 can be suppressed.

When the first temperature measuring element 7 and the second temperature measuring element 8 are made of salicide, a temperature coefficient of resistivity of the first temperature measuring element 7 and a temperature coefficient of resistivity of the second temperature measuring element 8 are larger than or equal to five times that of a material (for example, titanium nitride (TiN)) that is normally used as a heater. Therefore, since the first temperature measuring element 7 and the second temperature measuring element 8 are made of a material having a higher temperature coefficient than TiN or the like, the first temperature measuring element 7 and the second temperature measuring element 8 can detect a change in temperature with higher accuracy, and are suitable as temperature monitors.

For example, in the phase shifter 1, a current is supplied to the first temperature measuring element 7, and the resistance value of the first temperature measuring element 7 is monitored by measuring a potential difference between the first end portion and the second end portion of the first temperature measuring element 7 when a current is supplied. The resistance value of the second temperature measuring element 8 is also monitored in the same manner as above. When the first temperature measuring element 7 and the second temperature measuring element 8 are made of salicide, a small constant current (for example, a current of 100 μA or less) can be used as the above-described current. In this case, the possibility that the resistance value of the first temperature measuring element 7 and the resistance value of the second temperature measuring element 8 change due to long-term use or the like can be reduced.

For example, the second end portion of the first temperature measuring element 7 may be connected to the second end portion of the second temperature measuring element 8. As one example, the second end portion of the first temperature measuring element 7 is electrically connected to the second end portion of the second temperature measuring element 8 via the second electrode 10c. In this case, the first temperature measuring element 7 and the second temperature measuring element 8 can be used as one monitor resistor. The series resistance value of the first temperature measuring element 7 and the second temperature measuring element 8 may be monitored by measuring a potential difference between the first end portion of the first temperature measuring element 7 and the first end portion of the second temperature measuring element 8. Incidentally, instead of the second electrode 10c, the second end portion of the first temperature measuring element 7 may be electrically connected to one first electrode 10b, the second end portion of the second temperature measuring element 8 may be electrically connected to another first electrode 10b, and the two first electrodes 10b may be electrically connected to each other by a wiring.

The first temperature measuring element 7 and the second temperature measuring element 8 are disposed along the heating element 5. Namely, the first temperature measuring element 7 and the second temperature measuring element 8 are disposed at positions adjacent to the heating element 5 in the vertical direction D1 to extend along the same direction as the direction in which the heating element 5 extends (extending direction D3). Therefore, the average temperature of the entirety of the heating element 5 can be monitored by the first temperature measuring element 7 and the second temperature measuring element 8. The first temperature measuring element 7 and the second temperature measuring element 8 are disposed to sandwich the optical waveguide 4 therebetween in the horizontal direction D2. Since heat from the heating element 5 is conducted through the SiO2 layer 3 and the substrate 2, and is dissipated to the surroundings, an error between the monitored temperature and the actual temperature of the optical waveguide 4 can be reduced by disposing the optical waveguide 4 inside the first temperature measuring element 7 and the second temperature measuring element 8.

The phase shifter 1 includes grooves 9 on both respective sides of the heating element 5 in the horizontal direction D2. The phase shifter 1 includes a pair of the grooves 9 arranged along the horizontal direction D2. For example, the groove 9 has a rectangular shape. In a plan view along the vertical direction D1, the groove 9 has an oblong shape having first sides extending along the extending direction D3, and second sides extending along the horizontal direction D2. For example, a length of the second sides of the groove 9 is shorter than a length of the groove 9 in the vertical direction D1. For example, the length of the groove 9 in the vertical direction D1 is shorter than a length of the first sides of the groove 9.

For example, a length of the groove 9 in the extending direction D3 is shorter than the length of the first temperature measuring element 7 in the extending direction D3, and is shorter than the length of the second temperature measuring element 8 in the extending direction D3. The length of the optical waveguide 4 in the extending direction D3 is longer than the length of the first temperature measuring element 7 in the extending direction D3, and is longer than the length of the second temperature measuring element 8 in the extending direction D3. Since the grooves 9 are formed on both respective sides of the optical waveguide 4 in the horizontal direction D2, the thermal conduction of heat generated by the heating element 5 in the horizontal direction D2 is blocked by the grooves 9. Therefore, the optical waveguide 4, the first temperature measuring element 7, and the second temperature measuring element 8 can be efficiently heated with a small amount of electric power.

In addition, since the temperature distribution inside the SiO₂ layer 3 sandwiched between the pair of grooves 9 in a plan view along the vertical direction D1 can be made uniform by blocking thermal conduction in the horizontal direction D2, the accuracy of temperature monitoring by the first temperature measuring element 7 and the second temperature measuring element 8 can be improved. As described above, in the case of the phase shifter 1 including the grooves 9, compared to a phase shifter without the grooves 9, the electric power consumption required to obtain the same amount of phase shift can be reduced by 35% due to the effect of increase in thermal resistance. Therefore, the electric power efficiency of the heating element 5 can be improved by approximately 54%.

Next, actions and effects obtained from the phase shifter 1 according to the present embodiment will be described in more detail. In the phase shifter 1, the optical waveguide 4 is disposed in the vertical direction D1 with respect to the substrate 2. The phase shifter 1 includes the optical waveguide 4, and the first temperature measuring element 7 and the second temperature measuring element 8 disposed to sandwich the optical waveguide 4 therebetween. The heating element 5 is disposed in the vertical direction D1 with respect to the first temperature measuring element 7 and the second temperature measuring element 8. The heating element 5 is disposed in the vertical direction D1 with respect to the optical waveguide 4, the first temperature measuring element 7, and the second temperature measuring element 8, and the optical waveguide 4 is disposed between the first temperature measuring element 7 and the second temperature measuring element 8. The first temperature measuring element 7 and the second temperature measuring element 8 located on both sides of the optical waveguide 4 in the horizontal direction D2 monitor the temperature of the optical waveguide 4, and electric power to the heating element 5 is controlled such that the monitored temperature reaches a predetermined value, so that the temperature of the optical waveguide 4 can be stabilized to reach the predetermined value. Therefore, even when the resistance value of the heating element 5 changes due to long-term use or the like, electric power to the heating element 5 can be controlled according to the monitored temperature, so that a deviation in the amount of phase shift due to the change in resistance value can be compensated for and the amount of phase shift can be stabilized.

As described above, in a plan view along the vertical direction D1, the heating element 5 may include the portion 5b overlapping the optical waveguide 4, and the portion 5c overlapping at least one of the first temperature measuring element 7 and the second temperature measuring element 8. In this case, since the heating element 5 includes the portion 5b overlapping the optical waveguide 4, and the portion 5c overlapping at least one of the first temperature measuring element 7 and the second temperature measuring element 8, at least one of the first temperature measuring element 7 and the second temperature measuring element 8 is heated by the heating element 5 in the same manner as the optical waveguide 4, and the temperature of the optical waveguide 4 and the temperature of at least one of the first temperature measuring element 7 and the second temperature measuring element 8 can be made to approach each other uniformly. Therefore, since the temperature of the optical waveguide 4 can be monitored with higher accuracy by at least one of the first temperature measuring element 7 and the second temperature measuring element 8, the amount of phase shift can be further stabilized.

As described above, the optical waveguide 4 may be made of silicon, and the first temperature measuring element 7 and the second temperature measuring element 8 may be made of salicide. A temperature coefficient of the resistance value of salicide is approximately five times a temperature coefficient of the resistance value of titanium nitride (TiN). Therefore, when the first temperature measuring element 7 and the second temperature measuring element 8 are made of salicide, the sensitivity of the first temperature measuring element 7 and the second temperature measuring element 8 to changes in temperature can be enhanced. As a result, the temperature of the optical waveguide 4 can be monitored with higher accuracy, so that the amount of phase shift can be further stabilized.

As described above, one end of the first temperature measuring element 7 may be connected to one end of the second temperature measuring element 8. In this case, the first temperature measuring element 7 is connected in series to the second temperature measuring element 8. By connecting the first temperature measuring element 7 in series to the second temperature measuring element 8, the resistance values of the first temperature measuring element 7 and the second temperature measuring element 8 can be increased. Therefore, the accuracy of temperature detection based on changes in the resistance values of the first temperature measuring element 7 and the second temperature measuring element 8 can be further enhanced.

Next, various modification examples of the phase shifter according to the present disclosure will be described. Some configurations of a phase shifter according to each modification example to be described below are the same as some configurations of the phase shifter 1 described above. Therefore, in the following description, portions that overlap with the configuration of the phase shifter 1 are denoted by the same reference signs, and description thereof will be omitted as appropriate.

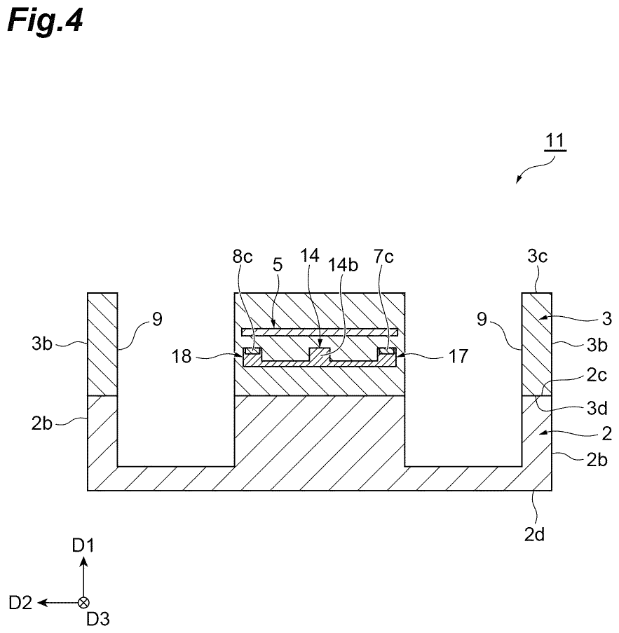

FIG. 4 is a cross-sectional view showing a phase shifter 11 according to a first modification example. The phase shifter 11 includes a ridge-type optical waveguide 14, a first temperature measuring element 17, and a second temperature measuring element 18. The phase shifter 11 includes the ridge-type optical waveguide 14 instead of the optical waveguide 4 described above. For example, the optical waveguide 14 is located between the first temperature measuring element 17 and the second temperature measuring element 18 in the horizontal direction D2. The optical waveguide 14 includes a silicon layer 14b constituting the optical waveguide 14. The first temperature measuring element 17 includes the silicon layer 14b and the salicide layer 7c located on the upper side of the silicon layer 14b. The second temperature measuring element 18 includes the silicon layer 14b and the salicide layer 8c located on the upper side of the silicon layer 14b.

Namely, the silicon layer 14b extends along the horizontal direction D2 from the first temperature measuring element 17 to the second temperature measuring element 18, and the first temperature measuring element 17 and the second temperature measuring element 18 are formed on the silicon layer 14b. As described above, in the phase shifter 11, the optical waveguide 14, the first temperature measuring element 17, and the second temperature measuring element 18 are connected to each other by the common silicon layer 14b. Since the first temperature measuring element 17 and the second temperature measuring element 18 are connected to the optical waveguide 14 by the silicon layer 14b, a difference between the temperature of the first temperature measuring element 17 and the second temperature measuring element 18 and the temperature of the optical waveguide 14 is reduced. Therefore, the effect of being able to further reduce temperature measurement errors can be obtained. Incidentally, portions (connecting portions) of the silicon layer 14b that connect the first temperature measuring element 17 and the second temperature measuring element 18 to the optical waveguide 14 have a length (thickness) smaller than a length of the silicon layer 14b of the optical waveguide 14 in the vertical direction D1. Accordingly, the influence of providing the connecting portions on the propagation of the optical signal through the optical waveguide 14 is suppressed.

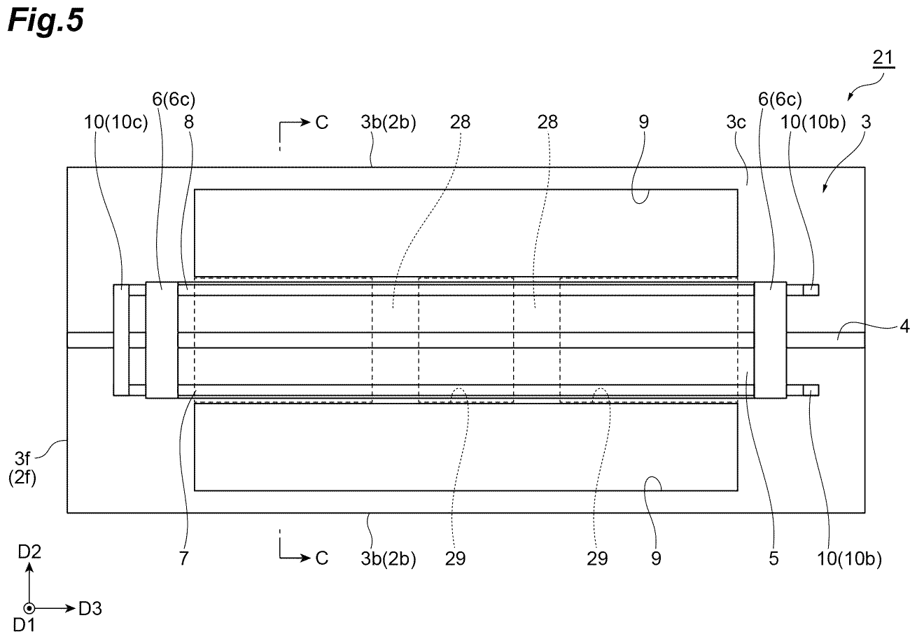

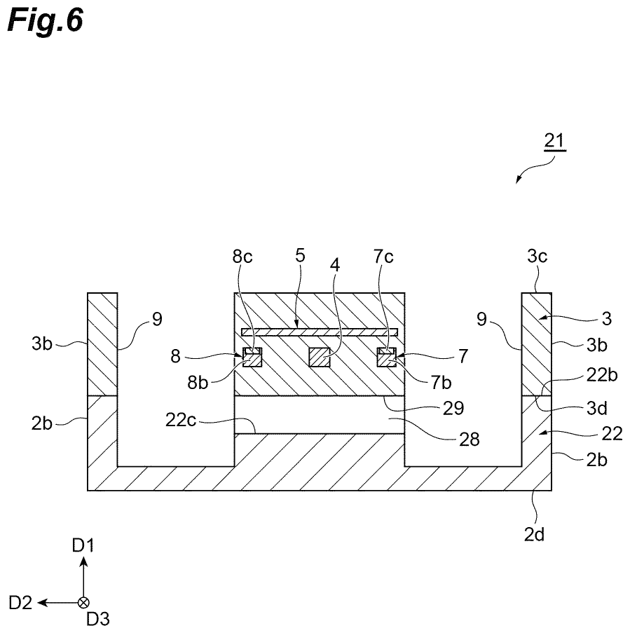

FIG. 5 is a plan view showing a phase shifter 21 according to a second modification example. FIG. 6 is a cross-sectional view taken along line C-C of FIG. 5. As shown in FIGS. 5 and 6, the phase shifter 21 includes a space portion 29 below the SiO₂ layer 3 (the optical waveguide 4, the heating element 5, the first temperature measuring element 7, and the second temperature measuring element 8). The space portion 29 is a hollow portion surrounded by the substrate 22 and the SiO₂ layer 3 in the vertical direction D1 and the extending direction D3. For example, the space portion 29 has a rectangular parallelepiped shape. The phase shifter 21 includes a plurality of the space portions 29, and the plurality of space portions 29 are arranged along the extending direction D3.

The phase shifter 21 includes, for example, the substrate 22 having a shape different from that of the substrate 2 described above. The substrate 22 has a first upper surface 22b that comes into contact with the lower surface 3d of the SiO₂ layer 3, and a second upper surface 22c that is separated downward from the lower surface 3d of the SiO₂ layer 3. Portions formed between the lower surface 3d of the SiO₂ layer 3 and the second upper surface 22c are the space portions 29. The space portions 29 are formed in the substrate 22 by, for example, etching.

The phase shifter 21 includes a support portion 28 that supports the SiO₂ layer 3. The support portion 28 is disposed between two space portions 29 arranged along the extending direction D3. A portion of the first upper surface 22b of the substrate 22, which comes into contact with the lower surface 3d of the SiO₂ layer 3, serves the support portion 28. FIG. 5 shows an example in which three space portions 29 arranged along the extending direction D3 and two support portions 28 arranged along the extending direction D3 are formed. However, the number and disposition mode of the space portions 29 and the support portions 28 are not particularly limited.

As described above, in the phase shifter 21, the space portions 29 are formed between the optical waveguide 4, the first temperature measuring element 7, and the second temperature measuring element 8 and the substrate 22. Since the thermal conduction of heat generated by the heating element 5 to the substrate 22 is reduced by the space portions 29, the thermal insulation of the optical waveguide 4, the first temperature measuring element 7, and the second temperature measuring element 8 can be enhanced. Accordingly, the accuracy of temperature measurement by the first temperature measuring element 7 and the second temperature measuring element 8 can be enhanced, and the electric power efficiency of temperature control of the optical waveguide 4 by the heating element 5 can be increased.

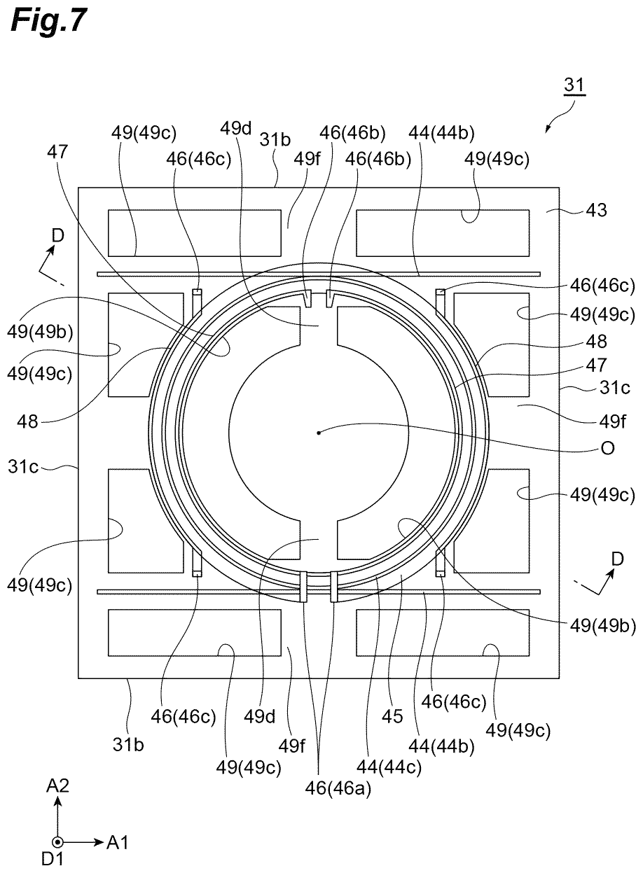

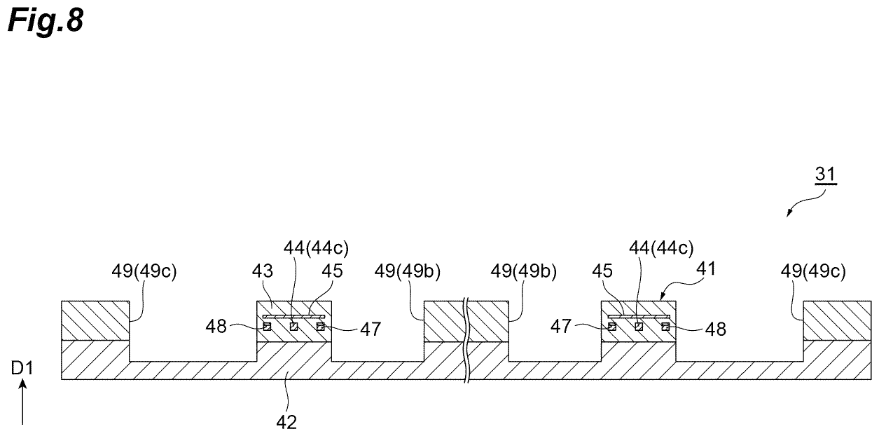

Next, a wavelength selector 31 according to a second embodiment will be described with reference to FIGS. 7 and 8. FIG. 7 is a plan view showing the wavelength selector 31 when viewed along the vertical direction D1. FIG. 8 is a cross-sectional view taken along line D-D of FIG. 7. For ease of illustration, each component is shown by a solid line in FIG. 7. As shown in FIGS. 7 and 8, the wavelength selector 31 is a ring resonator. The wavelength selector 31 includes a phase shifter 41. Some configurations and functions of the phase shifter 41 are the same as the configurations and functions of the phase shifter 1 described above. Therefore, among the configurations and functions of the phase shifter 41, the description of the same contents as those of the configurations and functions of the phase shifter 1 described above will be omitted.

In a plan view along the vertical direction D1, the wavelength selector 31 has a pair of first sides 31b extending along a first direction A1 perpendicular to the vertical direction D1, and a pair of second sides 31c extending along a second direction A2 perpendicular to both the vertical direction D1 and the first direction A1. The pair of first sides 31b are arranged along the second direction A2, and the pair of second sides 31c are arranged along the first direction A1.

By the way, similarly to the phase shifter 21 described above, the wavelength selector 31 can be formed as a part of a photonic integrated circuit on a silicon chip. In that case, a substrate 42 and a SiO₂ layer 43 are continuous with other portions of the photonic integrated circuit in the first direction A1 and the second direction A2, and the first sides 31b and the second sides 31c do not exist. Therefore, for the sake of convenience, the first sides 31b and the second sides 31c represent boundaries with the other portions of the wavelength selector 31.

The phase shifter 41 includes the substrate 42, the SiO₂ layer 43, an optical waveguide 44, a heating element 45, electrodes 46, a first temperature measuring element 47, a second temperature measuring element 48, and a groove 49. The optical waveguide 44 includes a pair of first optical waveguides 44b extending along the first direction A1, and a second optical waveguide 44c having a circular shape centered on a fixed point O between the pair of first optical waveguides 44b. The fixed point O is located between the pair of first optical waveguides 44b along the second direction A2. The optical waveguide 44 constitutes a ring resonator. In a plan view along the vertical direction D1, the second optical waveguide 44c and the heating element 45 have a circular shape centered on the fixed point O.

The heating element 45 is located above the second optical waveguide 44c, the first temperature measuring element 47, and the second temperature measuring element 48. In a plan view along the vertical direction D1, the heating element 45 has an arc shape of a circle centered on the fixed point O. The heating element 45 is formed such that a current flows in a circumferential direction of the arc, and the electrodes 46a are disposed at both ends. The electrodes 46a are electrically connected to the heating element 45. When a current flows from the first electrode 46a to the second electrode 46a, the heating element 45 generates Joule heat. In a plan view along the vertical direction D1, the first temperature measuring element 47 has an arc shape of a circle centered on the fixed point O. The phase shifter 41 includes a pair of the second temperature measuring elements 48 arranged along the first direction A1. The second temperature measuring elements 48 have an arc shape of a circle centered on the fixed point O. In a plan view along the vertical direction D1, the second temperature measuring elements 48 are provided outside the first temperature measuring element 47 with respect to the fixed point O. Namely, a distance of the second temperature measuring elements 48 from the fixed point O is larger than a distance of the first temperature measuring element 47 from the fixed point O. Electrodes 46b are provided at both respective ends of the first temperature measuring element 47, and electrodes 46c are provided at both respective ends of each of the second temperature measuring elements 48. Wirings (not illustrated) are connected to the electrodes 46b and 46c. For example, the first temperature measuring element 47 and the second temperature measuring elements 48 may be connected in series to each other.

The phase shifter 41 includes a plurality of the grooves 49. The plurality of grooves 49 include a first groove 49b located inside the heating element 45 in a plan view along the vertical direction D1, and a second groove 49c located outside the heating element 45 in a plan view along the vertical direction D1. For example, a distance of the first groove 49b from the fixed point O is smaller than a distance of the second groove 49c from the fixed point O. The phase shifter 41 includes a pair of the first grooves 49b arranged along the first direction A1. The pair of first grooves 49b are disposed at positions where the pair of first grooves 49b sandwich the electrodes 46 therebetween in the first direction A1. The phase shifter 41 includes a plurality of the second grooves 49c. The plurality of second grooves 49c are arranged along the first direction A1, and are arranged along the second direction A2. For example, the plurality of second grooves 49c are disposed to surround the heating element 45 thereinside in a plan view along the vertical direction D1. The phase shifter 41 includes a region 49d located between the pair of first grooves 49b and regions 49f located between the plurality of second grooves 49c in a plan view along the vertical direction D1. The pair of first grooves 49b are separated from each other by the region 49d. The plurality of second grooves 49c are separated from each other by the regions 49f. At least one of the region 49d and the regions 49f is a region where a wiring or the like can be disposed on the SiO₂ layer 43.

As described above, the wavelength selector 31 according to the second embodiment includes the phase shifter 41, and the phase shifter 41 provides the same actions and effects as the phase shifter 1 and the like described above. In the wavelength selector 31, similarly to the phase shifter 1, the temperature of the second optical waveguide 44c can be monitored by the first temperature measuring element 47 located inside the second optical waveguide 44c with respect to the fixed point O, and the second temperature measuring elements 48 located outside the second optical waveguide 44c with respect to the fixed point O. Further, electric power to the heating element 45 is controlled such that the monitored temperature reaches a predetermined value. Therefore, the temperature of the second optical waveguide 44c can be stabilized to reach the predetermined value. Therefore, even when the resistance value of the heating element 45 changes due to long-term use or the like, electric power to the heating element 45 can be controlled according to the monitored temperature, so that a deviation in the amount of phase shift can be compensated for and the amount of phase shift can be stabilized.

Various embodiments and modification examples of the phase shifter and the wavelength selector according to the present disclosure have been described above. However, the present invention is not limited to each embodiment or each modification example described above, and may be further modified within the scope of the concept described in the claims. Namely, the configuration, shape, size, material, number, and disposition mode of each portion of the phase shifter and the wavelength selector can be modified as appropriate within the scope of the concept. For example, the wavelength selector according to the present disclosure may be combined with any of the phase shifters 1, the phase shifter 11, and the phase shifter 21 described above.

1. A phase shifter comprising:
a substrate;
an optical waveguide disposed in a vertical direction with respect to the substrate;
a first temperature measuring element and a second temperature measuring element disposed in a horizontal direction with respect to the optical waveguide, and disposed to sandwich the optical waveguide between the first temperature measuring element and the second temperature measuring element; and
a heating element disposed in the vertical direction with respect to the optical waveguide, the first temperature measuring element, and the second temperature measuring element.

2. The phase shifter according to claim 1,
wherein in a plan view along the vertical direction, the heating element includes a portion overlapping the optical waveguide, and a portion overlapping at least one of the first temperature measuring element and the second temperature measuring element.

3. The phase shifter according to claim 1,
wherein the optical waveguide is made of silicon, and
the first temperature measuring element and the second temperature measuring element are made of salicide.

4. The phase shifter according to claim 1,
wherein one end of the first temperature measuring element is connected to one end of the second temperature measuring element.

5. A wavelength selector comprising:
the phase shifter according to claim 1.
